(19) United States
(12) Patent Application Publication
(10) Pub. No.: US 2011/0311670 A1
(43) Pub. Date: Dec. 22, 2011

(54) Moulded Plastics Cooling Apparatus

(76) Inventors: John Northcott, Abergele Conway (GB); Jason Barker, Abergele Conway (GB)

(21) Appl. No.: 12/990,601

(22) PCT Filed: Apr. 28, 2009
(86) PCT No.: PCT/GB09/01074

§ 371 Date: Sep. 6, 2011

(30) Foreign Application Priority Data
Apr. 28, 2008 (GB) 0807677.0

(51) Int. Cl. B29C 35/16

(52) U.S. Cl. 425/143; 425/404

(57) ABSTRACT

An apparatus for cooling moulds filled with a partially melted plastics waste in a water bath, and a method for use of such apparatus.

### FIELD OF THE INVENTION

The present invention concerns an apparatus for cooling moulds and their contents, in particular for moulds containing hot plastic that are used in the plastics recycling industry.

### BACKGROUND OF THE INVENTION

The recycling of plastic waste has become an important industry in many parts of the world. A particular challenge to this industry is in managing the recycling of waste comprised of a mix of different plastics, as is typically present in domestic plastic waste.

Plastics are often labeled with symbols corresponding with the resin identification coding system developed by the Society of the Plastics Industry (SPI), and this enables the recycling industry to identify the broad type of a plastic. In some cases plastics of a single SPI code can be re-melted and reused, for example being extruded into new relatively homogeneous products.

Separation of plastics by SPI code is labour intensive and consequently expensive. Not all plastics of a single SPI code can be reused melted together, and facilities for recycling plastics by type typically do not exist for all the different SPI codes. Consequently, for economic and viability reasons the plastics recycling industry also requires to recycle mixed plastics.

One method for recycling mixed plastics involves shredding and partially melting to form a mixture of molten and unmolten material that is injected into moulds and cooled to solidify. Apparatuses are already commercially available that perform the tasks of shredding mixed plastics, heating them to produce a semi-molten slurry of molten and solid material, and cooling the slurry after it has been injected into moulds.

The design of a commercially available cooling apparatus 100 is shown in FIG. 1. The apparatus comprises a carousel 102 having a number of cylindrical moulds 104a-104f. The carousel is partially submerged into a bath 106 of water 108 and is rotatable (in direction R) such that the moulds can be submerged and lifted from the water in turn.

In use, an empty mould 104a is filled 104b with semi-molten plastics slurry and the mould is sealed. The carousel is then rotated to submerge the filled mould 104c such that it is submerged in the bath of cool water, where the mould and the hot slurry it contains cool. Once sufficiently cool the mould 104f is raised out of the water bath, unsealed, and the solidified contents is ejected, leaving the mould ready for reuse.

The filling and ejection stages of the cycle are relatively quick when compared with the cooling stage, where the mould is submerged in the water bath. As a result the cooling stage is the rate-limiting step in the operation of this recycling process, considerably limiting the throughput of the shredding, heating and cooling apparatus.

Different designs of moulds, or similar moulds filled with different compositions of plastics may require different amounts of cooling time. However, it is a disadvantage of a prior art cooling apparatus with a carousel, as per FIG. 1, that it is difficult separately to control the duration of cooling applied to each mould since the movement of the moulds is interrelated, for example, since they are sequentially cooled as the carousel rotates the and passes the moulds through the cooling bath.

Thus a need remains in the industry for an alternative design of cooling apparatus.

### SUMMARY OF THE INVENTION

Described herein an improved cooling apparatus that overcomes at least some of the disadvantages described above.

In accordance with a first aspect of the present invention there is provided a cooling apparatus. The cooling apparatus comprises a plurality of moulds, a cooling bath and mould transfer mechanism. In use the cooling bath contains a liquid. The mould transfer mechanism is adapted to transfer moulds selectively into and out of the cooling liquid.

Selective transfer of moulds into and out of the cooling liquid enables efficient use to be made of the moulds and other apparatus associated with filling and/or emptying of the moulds.

The cooling apparatus may be provided with a mould emptying region.

The cooling apparatus may be provided with a mould filling region. The mould filling region may have a mould filling mechanism having an outlet with a controllable flow rate. The mould filling mechanism may have a plurality of outlets having controllable flow rates and a flow switch with which to switch a flow from an outlet to another outlet. The mould filling mechanism may have a plurality of mould supports.

Having a plurality of outlets with a flow switch enables more efficient use of the mechanism, enabling it to be pre-loaded with a further empty mould whilst filling a first mould, such that when the first mould is full the flow can be switched to filling the further mould.

The cooling bath may be provided with a plurality of cooling liquid input ports. The cooling bath may also be provided with a plurality of mould supports adapted to support moulds in a position such that they are submerged in the cooling liquid.

The mould transfer mechanism may comprise a moveable winch capable of attaching to moulds. The moveable winch may be mounted on an overhead rail that stretches above the cooling apparatus. The mould transfer mechanism may comprise a robotic arm capable of moving moulds into and out of the cooling bath.

The cooling liquid may be water or an aqueous solution.

A plastics recycling facility may comprise mechanisms to shred and at least partially melt plastics, and further comprising a cooling apparatus as described above. The cooling apparatus may be adapted to receive the at least partially melted plastic.

In accordance with a second aspect of the present invention there is provided a method of cooling moulds. The method comprises placing the moulds into a cooling bath containing a cooling liquid, cooling of the moulds by said cooling liquid, and subsequent removal of the moulds from the cooling bath. The moulds can be selectively transferred into and out of the cooling liquid by a mould transfer mechanism.

Prior to cooling the moulds may be filled by a filling mechanism with at least partially melted plastic. The filling mechanism may have an outlet with a controllable flow rate. The filling mechanism may have a plurality of outlets, each having a controllable flow rate. In the case that the filling mechanism has a plurality of outlets it may be further provided with a switch that in use enables an outlet flow to be switched from an outlet to another outlet.

A plastics recycling plant may be operated, in which plastic material is shredded, at least partially melted, the at least partially melted plastic material is filled into moulds, which are cooled according to the method described above.

### BRIEF DESCRIPTION OF THE DRAWINGS

For a better understanding of the present invention and to show more clearly how it may be carried into effect, reference will now be made, by way of example only, to the accompanying drawings, in which:

FIG. 1 is a schematic illustration of a known cooling apparatus.

FIG. 2 is a schematic illustration of a cooling apparatus according to the present invention.

FIG. 3 is a schematic illustration of a filling apparatus forming part of the cooling apparatus of FIG. 2.

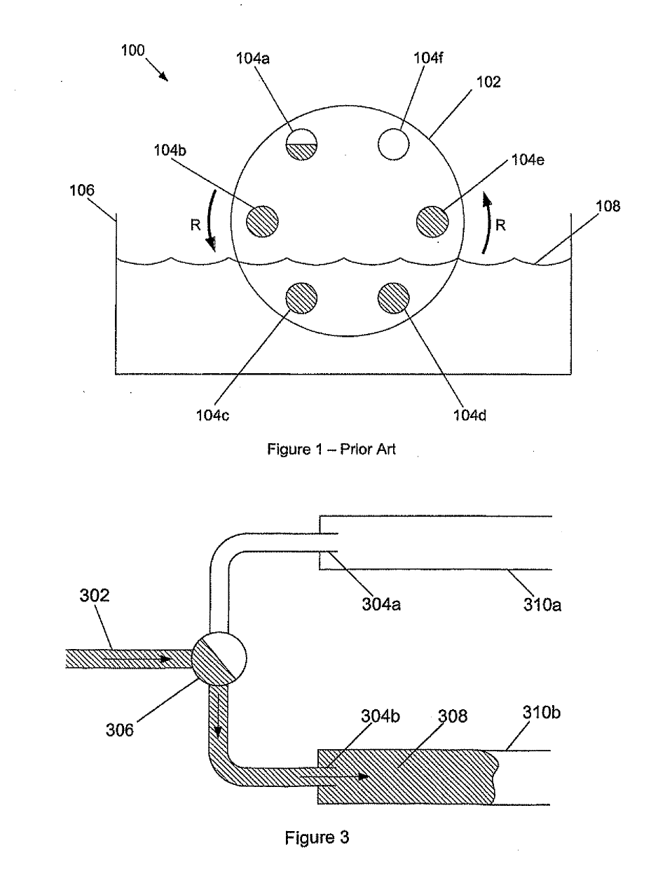

### DETAILED DESCRIPTION

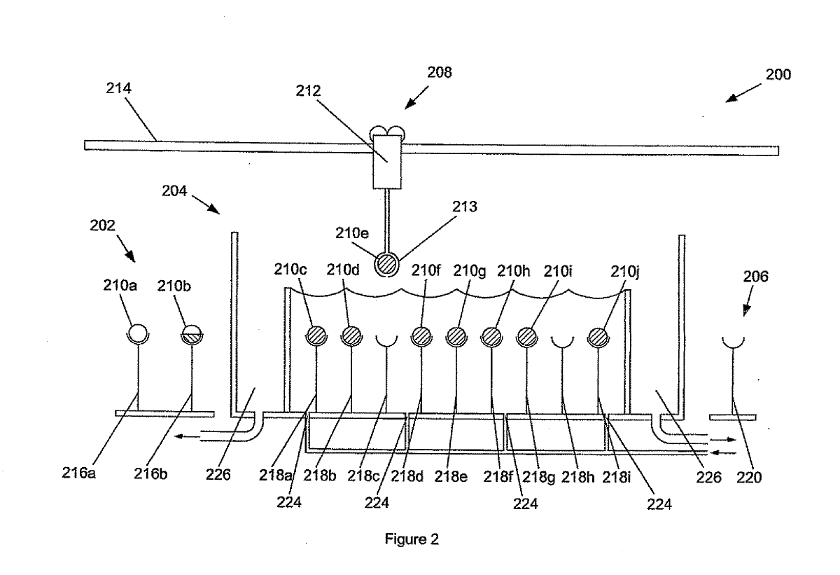

FIG. 2 of the accompanying drawings illustrates a cooling apparatus 200 according to a preferred embodiment of the present invention. The apparatus 200 comprises a mould filling region 202, a water bath 204, a mould emptying region 206, and a mould transfer mechanism 208 for transferring the moulds 210a-210j between the filling station, water bath and ejection station.

The mould transfer mechanism 208 is preferably a moveable winch 212 with a grabbing mechanism 213 mounted on an overhead rail 214, such that the winch can move along the rail above different parts of the cooling apparatus 200, so as to transfer moulds. Alternatively the mould transfer mechanism could be a robotic mechanism.

The filling station 202 comprises filling mould supports 216a-216b on which moulds 210a-210b can be rested whilst filled by a filling mechanism (not illustrated). The moulds are filled with either a completely melted plastic, or with a mixture in which pieces of plastic that have not melted are suspended in melted plastic. Once they have been filled, the moulds are transferred by the mould transfer mechanism 208 to one of the cooling mould supports 218a-218i in the water bath 204. Once the mould has cooled sufficiently in the water bath, it can then be transferred by the mould transfer mechanism 208 to the ejection station 206, where it is placed onto the ejection mould support 220, and the solidified contents is ejected from the mould by an ejection mechanism (not illustrated).

In the cooling apparatus of FIG. 2 the moulds can be independently moved. Advantageously this allows different moulds to be cooled in the water bath for different lengths of time, as required. For example, a control system may vary the time for which moulds are cooled in correspondence with the composition of the plastics material within the mould, which may change with variations in the waste plastics being processed by a plastics recycling plant.

To maintain the water in the water bath 204 at a substantially constant temperature, a continuous through-flow of water is provided. A preferred design of water bath has a central pool 222 of water, supplied by water inputs 224, and collected by overflow gullies 226.

FIG. 3 shows a preferred design of part of the filling mechanism of the filling station 202, in which an input pipe 302 is connected to one of two outlets 304a-304b by a mechanical flow switch 306, to enable control of a flow of semi-molten plastic 308 into moulds 310a-310b. The mechanical flow switch 306 allows the flow of semi-molten plastic 308 to be directed to one mould 310b, whilst a second mould that has been filled previously can be removed to the water bath and replaced with an empty mould 310a.

By provision of an apparatus with a sufficiently large number of moulds and a water bath with an adequate number of cooling mould supports 218, it is possible to operate the filling station 202 at maximum throughput, considerably improving the performance of a plastics recycling facility, relative to a carousel design of the prior art.

1. A cooling apparatus comprising
a plurality of moulds,
a cooling bath, which in use contains a cooling liquid, and
a mould transfer mechanism adapted to selectively transfer moulds into and out of the cooling liquid.

2. The cooling apparatus according to claim 1 provided with a mould emptying region.

3. The cooling apparatus according to one of claims 1 and 2 provided with a mould filling region.

4. The cooling apparatus according to claim 3 provided with a mould filling mechanism having an outlet with a controllable flow rate.

5. The cooling apparatus according to claim 4, wherein the mould filling mechanism comprises a plurality of outlets having controllable flow rates and a flow switch with which to switch a flow from an outlet to another outlet.

6. The cooling apparatus according to one of claims 4 and 5, wherein the mould filling mechanism comprises a plurality of mould supports.

7. The cooling apparatus according to any preceding claim, wherein the cooling bath is provided with a plurality of cooling liquid input ports.

8. The cooling apparatus according to any preceding claim wherein the cooling bath is provided with a plurality of mould supports adapted to support moulds in a position such that they are submerged in the cooling liquid.

9. The cooling apparatus according to any preceding claim, wherein the mould transfer mechanism comprises a moveable winch capable of attaching to moulds, mounted on an overhead rail that stretches above the cooling apparatus.

10. The cooling apparatus according to any preceding claim, wherein the mould transfer mechanism comprises a robotic arm capable of moving moulds into and out of the cooling bath.

11. The cooling apparatus according to any preceding claim, wherein the cooling liquid is water or an aqueous solution.

12. A plastics recycling facility comprising mechanisms to shred and at least partially melt plastics, and further comprising a cooling apparatus according to any preceding claim, wherein the cooling apparatus is adapted to receive the at least partially melted plastic.

13. A method of cooling moulds wherein moulds are placed into a cooling bath containing a cooling liquid, cooled by said cooling liquid, and subsequently removed from the cooling bath, wherein the moulds can be selectively transferred into and out of the cooling liquid by a mould transfer mechanism.

14. A method according to claim 13, wherein prior to cooling the moulds are filled by a filling mechanism with at least partially melted plastic.

15. A method according to claim 14, wherein the filling mechanism has an outlet with a controllable flow rate.

16. A method according to claim 14, wherein the filling mechanism comprises a plurality of outlets each having a controllable flow rate.

17. A method according to one of claims 14 to 16, wherein the filling mechanism has a plurality of outlets and a switch that in use enables a flow to be switched from an outlet to another outlet.

18. A method of operating a plastics recycling plant in which plastic material is shredded, at least partially melted, the at least partially melted plastic material is filled into moulds, which are cooled according to the method of one of claims 14 to 17.

19. A device substantially as hereinbefore described with reference to and as illustrated in FIGS. 2 and 3.
